(19) United States
(12) Patent Application Publication
(10) Pub. No.: US 2012/0007819 A1
(43) Pub. Date: Jan. 12, 2012

(54) Automatic Convergence Based on Touchscreen Input for Stereoscopic Imaging

(76) Inventors: Gregory Robert Hewes, Sachse, TX (US); Fred William Ware, JR., Carrollton, TX (US); Wei Hong, Sunnyvale, CA (US); Mark Noel Gamadia, Longmont, CO (US)

(21) Appl. No.: 13/177,542

(22) Filed: Jul. 6, 2011

Related U.S. Application Data
(60) Provisional application No. 61/362,481, filed on Jul. 8, 2010.

(51) Int. Cl. G06F 3/041; H04N 13/02

(52) U.S. Cl. 345/173; 348/46; 348/E13.074

(57) ABSTRACT

A method is provided that includes receiving coordinates of a touch point on a touchscreen, wherein the touch point indicates a user-selected convergence point, and converging a stereoscopic image at the user-selected convergence point based on the touch point coordinates.

### CROSS-REFERENCE TO RELATED APPLICATIONS

This application claims benefit of U.S. Provisional Patent Application Ser. No. 61/362,481, filed Jul. 8, 2010, which is incorporated by reference herein in its entirety. This application is related to the co-pending and commonly assigned U.S. patent application Ser. No. ______, filed Jul. ______, 2011 (TI-69382).

### BACKGROUND OF THE INVENTION

1. Field of the Invention

Embodiments of the present invention generally relate to a method and apparatus for automatically converging stereoscopic images based on touchscreen input.

2. Description of the Related Art

In human visual systems or stereoscopic camera systems, the point of intersection of the two eye axes or two camera axes is the convergence point. The distance from the convergence point to the eye or camera is the convergence distance. For human eyes, the convergence point can be at arbitrary distance. For stereoscopic cameras, the convergence point may be, for example, at infinity (for a parallel camera configuration) or at a fixed distance (for a toe-in camera configuration).

When a person looks at a stereoscopic image or video on a stereoscopic display, the eyes naturally converge to the display screen. The distance from the display screen to the eyes is the natural convergence distance. However, to view the 3D effect correctly, the viewer's eyes adjust to have the same convergence distance as the camera. Such constant convergence distance adjustment can cause discomfort over time such as headaches or eye muscle pain.

### SUMMARY

Embodiments of the present invention relate to a method, apparatus, and computer readable medium for automatic convergence of stereoscopic images. The method includes receiving coordinates of a touch point on a touchscreen, wherein the touch point indicates a user-selected convergence point, and converging a first stereoscopic image at the user-selected convergence point based on the touch point coordinates.

### BRIEF DESCRIPTION OF THE DRAWINGS

Particular embodiments in accordance with the invention will now be described, by way of example only, and with reference to the accompanying drawings:

FIG. 1 shows a block diagram of a stereoscopic imaging system in accordance with one or more embodiments;

FIGS. 2 and 3 show flow diagrams of methods in accordance with one or more embodiments;

FIGS. 4A-4E, 5A, and 5B show examples in accordance with one or more embodiments; and

FIG. 6 shows a block diagram of an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

A stereoscopic image is a three dimensional (3D) representation of a scene. Further, a stereoscopic image may include two two dimensional (2D) images, a left image and a right image, that are obtained, for example, by imaging sensors positioned at slightly different viewpoints such that the same objects appear in each image but are shifted horizontally in one image relative to the other. Further, objects at different depths in the scene will have different displacements in the left and right images, thus creating a sense of depth when the stereoscopic image is viewed on a stereoscopic display. The left and right 2D images may be corresponding frames of two video sequences or corresponding single still 2D images. Thus, a stereoscopic image may be two corresponding frames of two video sequences or two corresponding still 2D images.

The term disparity refers to the shift that occurs at each point in a scene between the left and right images. This shift may be mostly horizontal when the imaging sensors used to capture the left and right images are offset horizontally. Further, the amount of shift or disparity may vary from pixel to pixel depending on the depth of the corresponding 3D point in the scene. At the point of convergence, corresponding objects in the left and right images are said to have zero horizontal disparity and, when viewed on a stereoscopic display, will appear to be on the display plane. Objects in front of the convergence point will have negative disparity, i.e., an object in the left image is horizontally shifted to the right of the corresponding object in the right image, and will appear in front of the display plane. Objects behind the convergence point will have positive disparity, i.e., an object in the left image is horizontally shifted to the left of the corresponding object in the right image, and will appear to be behind the display plane.

To improve viewing comfort, the convergence distance of a stereoscopic image can be adjusted so that the convergence distance approximates the natural convergence distance of human eyes. Such adjustment of the convergence distance may be accomplished by horizontally shifting the left image and/or the right image of the stereoscopic image, i.e., by changing the disparity between the left and right images.

Embodiments of the invention provide for automatic convergence of stereoscopic images based on touchscreen input. More specifically, the convergence distance of one or more stereoscopic images is automatically reduced based on a point indicated by touching a touchscreen. In one or more embodiments, a user may indicate a desired convergence point by touching a touchscreen while viewing stereoscopic images on the touchscreen. Horizontal shift amounts and directions are then determined based on the desired convergence point such that when a left image and/or a right image of a stereoscopic image are shifted according to these values, any object at the point indicated by the user's touch appears to be on the display plane when viewed on a stereoscopic display.

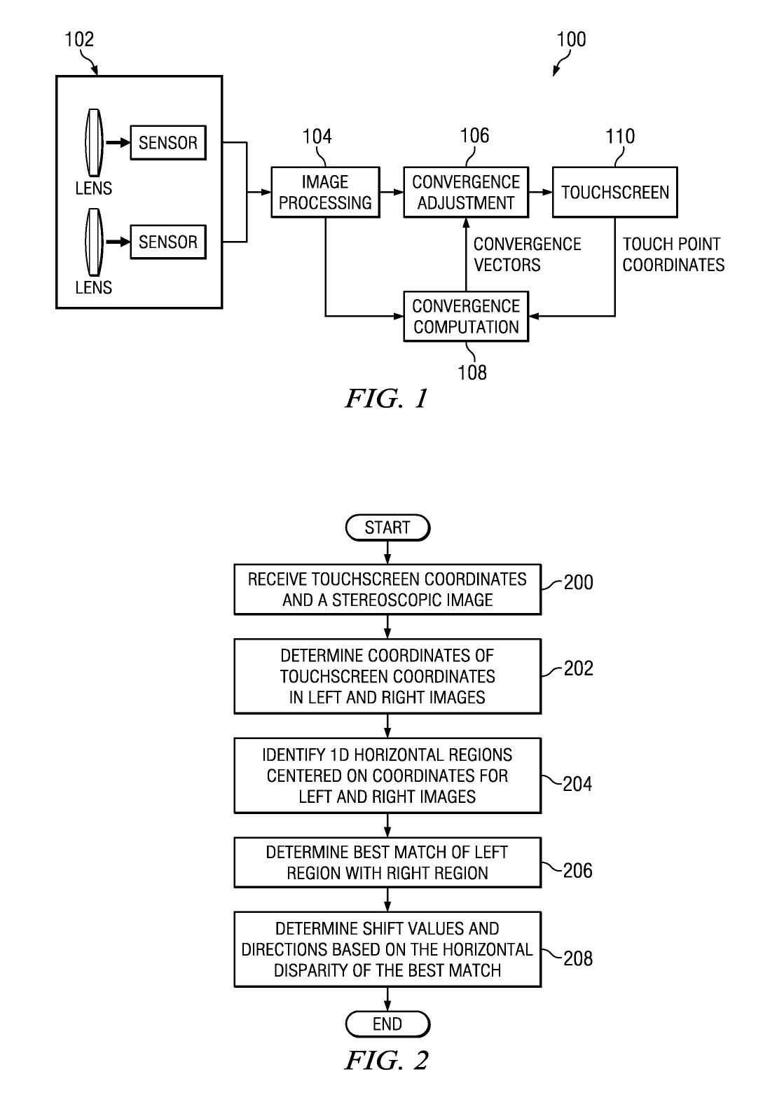

FIG. 1 shows a block diagram of stereoscopic imaging system 100 in accordance with one or more embodiments. The stereoscopic imaging system 100 includes a stereo imaging component 102, an image processing component 104, a convergence adjustment component 106, a convergence computation component 108, and a touchscreen 110.

The stereo imaging component 102 includes two lens configurations, two apertures, and two imaging sensors arranged to capture image signals of a scene from a left viewpoint and a right viewpoint. That is, one lens configuration, aperture, and imaging sensor is arranged to capture an image signal from the left viewpoint, i.e., a left analog image signal, and the other lens configuration, aperture, and imaging sensor is arranged to capture an image signal from the right view point, i.e., a right analog image signal. A lens configuration and aperture may be any suitable lens configuration and aperture. For example, a lens configuration may include a zoom lens and a focus lens. An imaging sensor may be any suitable imaging sensor such as, for example, a CMOS (Complementary Metal-Oxide Semiconductor) or CCD (Charge Coupled Device) image sensor. The stereo imaging component 102 also includes circuitry for controlling various aspects of the operation of the component, such as, for example, lens position, aperture opening amount, exposure time, etc. The stereo imaging component 102 further includes functionality to convert the left and right analog image signals to left and right digital image signals and to provide the left and right digital image signals to the image processing component 104.

The image processing component 104 divides the left and right digital signals into left and right digital images, and processes each digital image to enhance the scene in the digital image. The image processing performed may include one or more image enhancement techniques such as, for example, black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment.

The convergence adjustment component 106 shifts left and right images of a stereoscopic image horizontally according to a respective shift amount and shift direction, i.e., a respective convergence vector, determined by the convergence computation component 108. The convergence adjustment component 106 outputs the resulting stereoscopic images for further processing. The further processing may include, for example, displaying the stereoscopic images on the touchscreen 110, displaying the stereoscopic images on a stereoscopic display operatively connected to the stereoscopic imaging system, and encoding the stereoscopic images for storage and/or transmission.

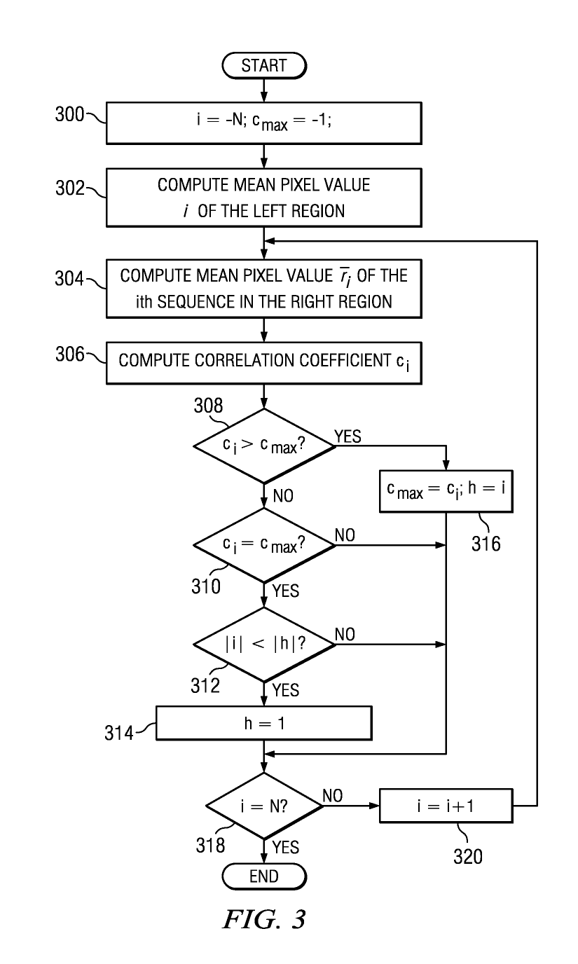

The convergence computation component 108 determines how much and in which direction each of the left and right images of stereoscopic images should be shifted horizontally based on a convergence point selected by user input on the touchscreen 110. More specifically, the convergence computation component 108 receives the coordinates of a point on the touchscreen 110 touched by the user to indicate a desired convergence point. This point is referred to as the screen touch point herein. The convergence computation component then generates shift amounts and directions for left and right images of stereoscopic images based on the screen touch point, and provides these shift amounts and directions to the convergence adjustment component 106 as convergence vectors. The shift amounts and directions, when applied, will cause a left image and a right image to converge at the touch screen point. A method for determining the appropriate shift amounts and directions that may be used by the convergence computation component 108 is described below in reference to FIGS. 2, 3, and 4.

The touchscreen 110 is a display screen with a touch panel overlay. The display screen is configured to present stereoscopic images to the user of the stereoscopic imaging system 100. In some embodiments, the display screen is a 2D display device such as a 2D liquid crystal display (LCD) and one of either the left image or the right image of a stereographic image is displayed. In some embodiments, the display screen is a stereoscopic display configured to present stereoscopic images to a user of the stereographic imaging system 100 in a manner that allows stereoscopic vision. A stereoscopic display may be, for example, a 2D display device for which the stereoscopic images are converted to anaglyph images that require special glasses to view the 3D effect. A stereoscopic display may also be a display with optical components that enable viewing of the 3D effect without special glasses, such as, for example, a stereoscopic 3D LCD device or a stereoscopic 3D organic electroluminescent display device. The touch panel is a thin panel overlaying the display screen that can detect the presence and location of a touch within the display area of the display screen. The touch panel may detect the touch of a finger and/or the touch of a passive object, such as a stylus.

In some embodiments, the stereoscopic imaging system 100 may be configured to operate as follows to capture stereoscopic images of a scene, and to automatically converge those stereoscopic images based on touch input from the touchscreen 110. In general, left and right images of stereoscopic images of a scene are captured and processed by the stereoscopic imaging component 102 and the image processing component 104. The left and right images of the stereoscopic images are then shifted by the convergence adjustment component 106 using shift amounts and directions generated by the convergence computation component 108, if any. If no shift amounts and directions have been generated by the convergence computation component 108, default values may be used or no shifting may be performed. The final stereoscopic images are then displayed on the touchscreen 110.

If the user of the stereoscopic imaging system 100 touches the touchscreen 110 while viewing the stereoscopic images, a touch event is generated and communicated to the convergence computation component 108. The touch event includes the coordinates of the point on the touchscreen 110 indicated by the user. The convergence computation component then determines a convergence point based on these coordinates, and generates the appropriate shift amounts and directions to be applied by the convergence adjustment component 106. The convergence adjustment component then applies these shift amounts and directions to stereoscopic images until they are updated, e.g., another touch event occurs, or are otherwise canceled, e.g., the stereoscopic image capture is terminated.

The automatic convergence may be performed, for example, on preview stereoscopic images during view finding, on stereoscopic images that are being recorded, and on previously recorded stereoscopic images. In some embodiments, the components of the stereoscopic imaging system 100 are embodied in a single digital system. The single digital system may be, for example, a cellular telephone, a smart cellular telephone, a laptop computer, a netbook computer, a tablet computing device, or a handheld gaming device. In some embodiments, different components may be embodied in separate digital systems. For example, the stereoscopic imaging component and the image processing component may be embodied in a digital camera and the other components may be embodied in a digital system that receives processed stereoscopic images from the camera.

Components of the stereoscopic imaging system 100 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, any software instructions may be stored in memory (not specifically shown) in the stereoscopic imaging system 100 and executed by one or more processors. The software instructions may be initially stored in a computer-readable medium such as a compact disc (CD), a diskette, a tape, a file, memory, or any other computer readable storage device and loaded and stored on the stereoscopic imaging system 100. In some cases, the software instructions may also be sold in a computer program product, which includes the computer-readable medium and packaging materials for the computer-readable medium. In some cases, the software instructions may be distributed to the stereoscopic imaging system 100 via removable computer readable media (e.g., floppy disk, optical disk, flash memory, USB key), via a transmission path from computer readable media on another computer system (e.g., a server), etc.

FIG. 2 shows a flow diagram of a method for determining shift amounts and directions for convergence of stereoscopic images based on the coordinates of a point indicated by touching a touchscreen in accordance with one or more embodiments. The method may be applied in response to a touchscreen event indicated, for example, while a user is previewing stereoscopic images during view finding and/or while the user is viewing stereoscopic images that are being recorded and/or while a user is reviewing previously recorded stereoscopic images. Thus, the method operates asynchronously from the previewing and/or recording and/or reviewing. That is, previewing, recording, and/or reviewing of stereoscopic images is not halted when a touchscreen event occurs. Rather, the computation of the shift amounts/directions occurs in parallel to the previewing, recording, and/or reviewing.

As shown in FIG. 2, initially, the touchscreen coordinates and a stereoscopic image are received 200. The touchscreen coordinates indicate a point, i.e., a screen touch point, on a touchscreen a user has selected for convergence. The coordinates of the point in the left image and the right image that correspond to the screen touch point coordinates are then determined 202. The coordinates of this point will be the same in both images. Further, this point is referred to as the image touch point herein.

One dimensional (1D) horizontal spatial regions centered on the x coordinate of the image touch point in the left and right images are then identified 204. The lengths of these 1D horizontal regions are based on a disparity limit of the stereoscopic imaging system. That is, if the disparity limit is N, the length of the 1D horizontal region in the left image is 2N+1, i.e., the 1D region will encompass N pixels to the left of the image touch point pixel and N pixels to the right of the image touch point pixel. This region is referred to as the left region herein. Further, the length of the 1D horizontal region in the right image is 4N+1, i.e., the 1D region will encompass 2N pixels to the left of the image touch point pixel and 2N pixels to the right. This region is referred to as the right region herein. The disparity limit limits the amount an image can be shifted. Thus, the maximum value of the disparity limit may be determined by the maximum amount the stereoscopic imaging system can shift an image. In some embodiments, the disparity limit is user adjustable.

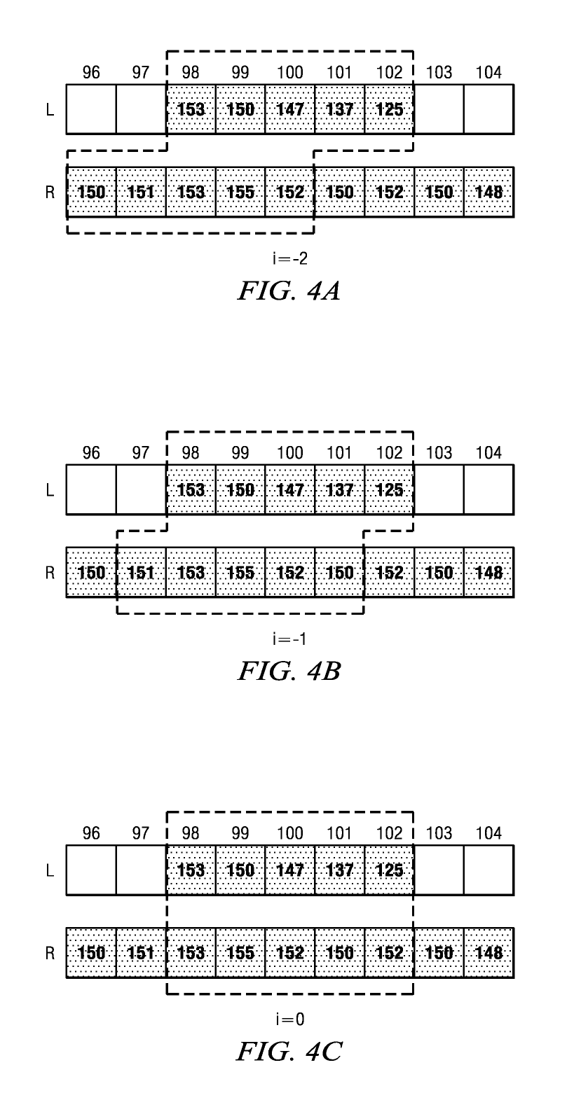

The right region is then searched for the sequence of 2N+1 pixels that best matches the 2N+1 pixels in the left region 206. This search may be performed by computing a measure of the correlation, i.e., a correlation coefficient, between the pixels in the left region and a sequence of 2N+1 pixels at each possible shift position across the right region. For a disparity limit of N, there are 2N+1 possible shift positions, −N to N. The sequence of 2N+1 pixels with the maximum correlation coefficient and the minimum absolute horizontal disparity is then selected as the best match. If two sequences have the same maximum correlation coefficient and minimum absolute horizontal disparity, the sequence with the negative minimum horizontal disparity is selected as the best match. A method for determining the best match is described in more detail below in reference to FIG. 3.

The horizontal disparity between the pixels in the left region and a sequence of 2N+1 pixels in the right region is the difference between the x coordinate of a pixel in the left region and the x coordinate of a pixel in the same relative location in the matching 2N+1 pixels. For example, the horizontal disparity is the difference between the x coordinate of the center pixel in the left region and the center pixel in the 2N+1 pixels in the right region. As is described in more detail below in reference to FIG. 3, this horizontal disparity is the equivalent of the shift amount corresponding to the matching 2N+1 pixels.

The shift amounts and shift directions to achieve convergence at the screen touch point are then determined based on the horizontal disparity h between the left region and the “matching” 2N+1 pixels in the right region 208. To determine the shift amounts, the horizontal disparity h is divided by 2. If h is an even integer, the shift amount for each image is |h|/2. If h is an odd integer, the shift amount for one image is rnd(|h|/2) and for the other image is rnd(|h|/2)−1. For example, if h=17, then h/2=8.5. The shift amount for one image may be 8 and for the other image may be 9. The shift directions are based on the sign of the horizontal disparity h. If h is negative, the shift direction for the left image is left and the shift direction for the right image is right. If h is positive, the shift direction for the left image is right and the shift direction for the right image is left.

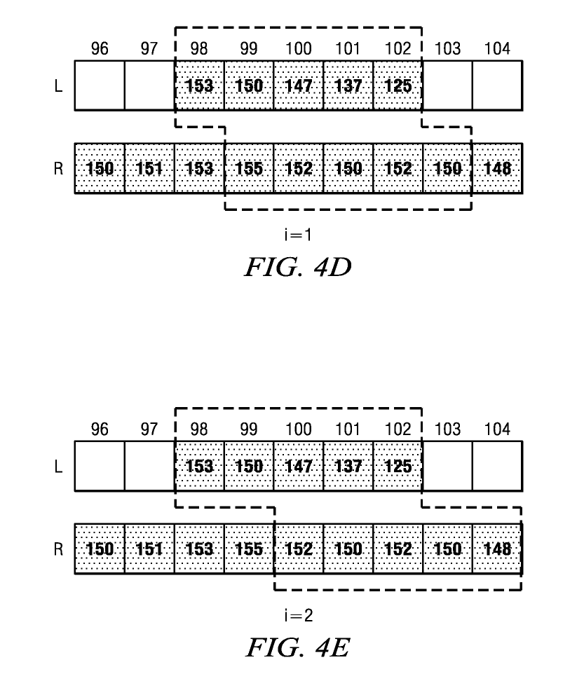

FIG. 3 shows a flow diagram of a method for finding a best match between the 2N+1 pixels of the left region and a sequence of 2N+1 pixels in the right region in accordance with one or more embodiments. To facilitate explanation, the method steps are described with reference to the simple example shown in FIGS. 4A-4E. In this example, N=2, so the length of the left region is 2(2)+1=5 and the length of the right region is 4(2)+1=9. The respective left and right regions in these figures are shaded. The numbers at the top are the X coordinates of the pixels in each region. The X coordinate of the center pixel, i.e., the image touch point, is 100.

Initially, an index i is set to −N and the maximum coefficient value cₘₐₓ is set to −1 300. The index i is the shift amount needed to align the pixels in the left region with a sequence of 2N+1 pixels in the right region and can range from −N to N. The first sequence of 2N+1 pixels for which a correlation coefficient is computed is the sequence at the far left of the right region, i.e., the sequence in the right image offset by a shift amount of −N from the image touch point. Turning to the example, the index i=−2, and FIG. 4A illustrates the sequence of pixels in the right region at this shift amount relative to the image touch point at X=100.

Referring again to FIG. 3, the mean pixel value l̅ for the left region is then computed 302. The mean pixel value is the sum of the pixel values divided by the number of pixels. In the example of FIG. 4, l̅=(153+150+147+137+125)/5=142.4. The mean pixel r̅ᵢ of the current pixel sequence in the right window is also computed 304. In the example of FIG. 4A, r̅₋₂=(150+151+153+155+152)/5=152.2.

A correlation coefficient cᵢ for the left region and the current pixel sequence in the right window is then computed 306. This correlation coefficient is computed as

$${c}_{i} = \frac{{\sum }_{m ∈ M} ( {I}_{m} - \overline{l} ) ( {r}_{m , i} - {\overline{r}}_{i} )}{\sqrt{{\sum }_{m ∈ M} {( {I}_{m} - \overline{l} )}^{2}} \sqrt{{\sum }_{m ∈ M} {( {r}_{m , i} - {\overline{r}}_{i} )}^{2}}}$$

$$M = \{ - N , … , N \}$$

where l̅ denotes the mean of the pixel values in the left region, lₘ denotes the pixel in the mth location in the left region, r̅ᵢ denotes the mean of the values of ith sequence of 2N+1 pixels in the right region, and r_{m, i} denotes the pixel at the mth location in the ith sequence of 2N+1 pixels in the right region.

If the computed correlation coefficient is greater than the maximum coefficient cₘₐₓ, cₘₐₓ is set to the computed correlation coefficient and the horizontal disparity h is set to the current value of the index i 316. The process then continues with the next shift position 320, if any 318. Note that the value of i is the horizontal disparity between a pixel in the left region and the pixel in the ith sequence of 2N+1 pixels in the right region in the same relative location.

When the method ends, i.e., after all shift positions from −N to N are processed, the value of cₘₐₓ will be the largest correlation coefficient value and the absolute value of h will be the smallest horizontal disparity associated with this largest correlation coefficient value. Further, if two or more correlation coefficients had the same largest correlation coefficient value and the same absolute value of h, h will be negative.

If the computed correlation coefficient is equal cₘₐₓ 310, then a check is made to determine if the absolute value of the index i is less than the absolute value of the current horizontal disparity h 312. If the test is true, then the horizontal disparity h is set to the current value of the index i 314. If it is not true, the value of h is not changed. Processing then continue with the next shift position 320, if any 318. Note that this test ensures that if two or more correlation coefficients have the same maximum value, and the same absolute horizontal disparity, a negative horizontal disparity is chosen over a positive horizontal disparity. The order in which the shift positions are processed, from −N to N, ensures that if two or more correlation coefficients have the same maximum value, the smallest absolute horizontal disparity is chosen.

Returning to the example, as previously mentioned, l̅=142.4. For the first iteration, as illustrated in FIG. 4A, i=−2, and r̅₋₂=152.2. Thus, c₋₂=−0.4591. The value of c₋₂ is greater than the current value of cₘₐₓ, so cₘₐₓ=c₋₂ and h=−2. The index i is then incremented to −1. For the second iteration, as illustrated in FIG. 4B, r̅₋₁=152.2 and c₋₁=0.5182. The value of c₋₁ is greater than the current value of cₘₐₓ, so cₘₐₓ=c₋₁ and h=−1. The index i is then incremented to 0. For the third iteration, as illustrated in FIG. 4C, r̅₀=152.4 and c₀=0.5319. The value of c₀ is greater than the current value of cₘₐₓ, so cₘₐₓ=c₀ and h=0. The index i is then incremented to 1. For the fourth iteration, as illustrated in FIG. 4D, r̅₁=151.8 and c₁=0.6122. The value of c₁ is greater than the current value of cₘₐₓ, so cₘₐₓ=c₁ and h=1. The index i is then incremented to 2. For the fifth, and final, iteration, as illustrated in FIG. 4E, r̅₂=150.4 and c₂=0.3530. The value of c₂ is not greater than the current value of cₘₐₓ, so cₘₐₓ and h are not changed. The final result is that cₘₐₓ=c₁ and h=1.

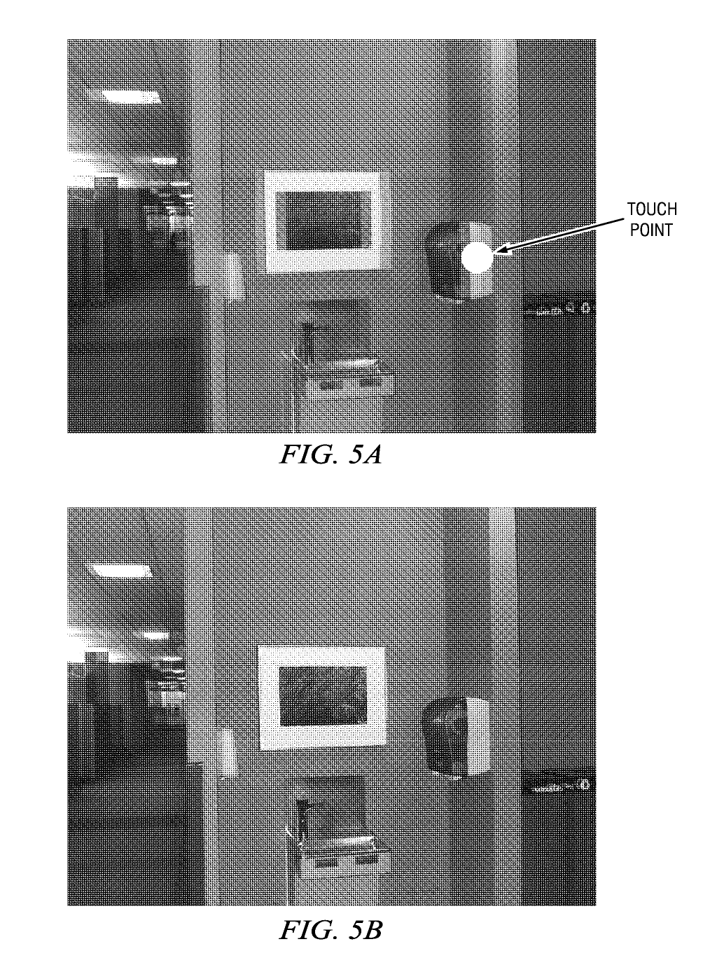

FIGS. 5A and 5B show a simple example of application of an embodiment of automatic convergence based on touchscreen input to a still stereoscopic image, i.e., a stereoscopic photograph. FIG. 5A shows the stereoscopic image before convergence with a touch point indicated in the scene. FIG. 5B shows the converged stereoscopic image after the automatic convergence at the indicated touch point is applied.

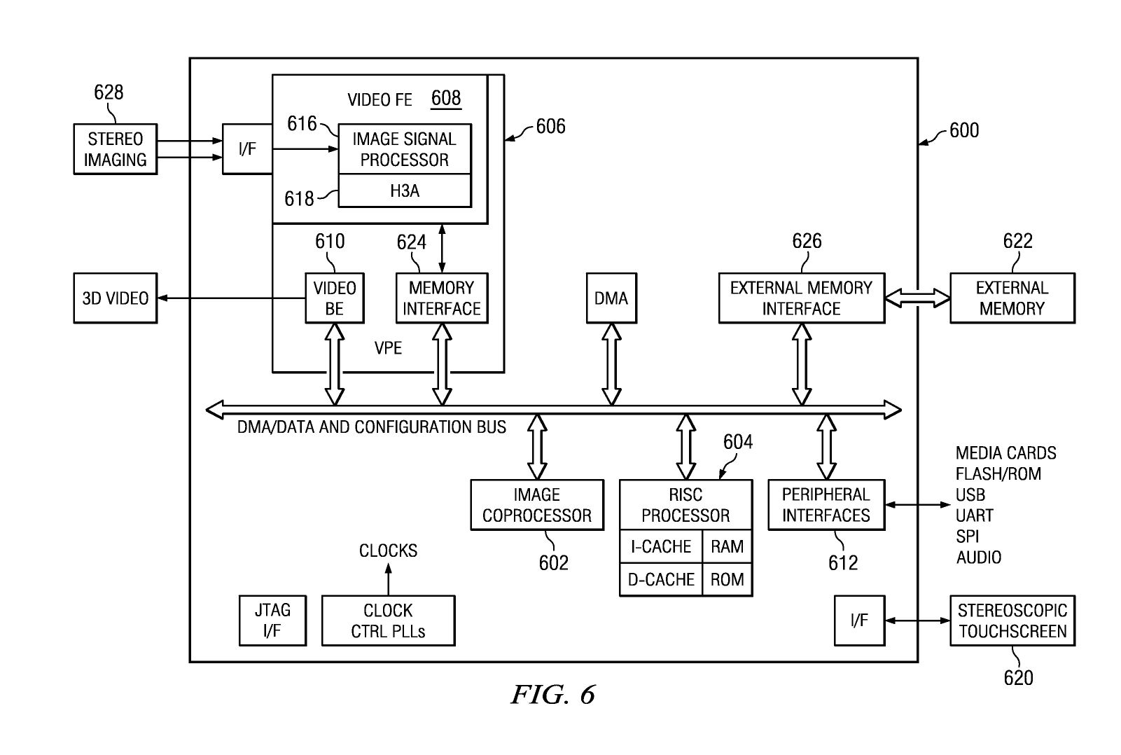

FIG. 6 shows an illustrative digital system 600 suitable for use as an embedded system, e.g., in a digital camera or a cellular telephone, in accordance with one or more embodiments. The digital system 600 includes, among other components, an image coprocessor (ICP) 602, a RISC processor 604, and a video processing engine (VPE) 606 that may be configured to perform automatic convergence of stereoscopic images as described herein. The digital system 600 also includes an interface for a stereoscopic touchscreen 620, an external memory interface 626, and peripheral interfaces 612 for various peripherals that may include a multi-media card, an audio serial port, a Universal Serial Bus (USB) controller, a serial port interface, etc.

The RISC processor 604 may be any suitably configured RISC processor. The ICP 602 may be, for example, a digital signal processor (DSP) or other processor designed to accelerate image processing. The VPE 606 includes a configurable video processing front-end (Video FE) 608 input interface used for stereoscopic image capture from a stereoscopic imaging peripheral 628, a configurable video processing back-end (Video BE) 610 output interface used for stereoscopic display devices, and a memory interface 624 shared by the Video FE 608 and the Video BE 610.

The Video FE 608 includes functionality to perform image enhancement techniques on raw stereoscopic image data from a stereoscopic imaging peripheral 616. The image enhancement techniques may include, for example, black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment. The Video FE 608 includes an image signal processor (ISP) 616, and an H3A statistic generator 3A) 618. The ISP 616 is customizable for various imaging sensor types, e.g., CCD or CMOS, and supports video frame rates for preview displays of captured stereoscopic images and for video and still image recording modes. The ISP 616 also includes, among other functionality, an image resizer, statistics collection functionality, and a boundary signal calculator. The H3A module 618 includes functionality to support control loops for auto focus, auto white balance, and auto exposure by collecting metrics on the raw image data from the ISP 616 or external memory 622.

The Video BE 610 includes functionality to manage display data in various formats for several different types of stereoscopic display devices, and to format display data into the output format and output signals required to interface to a stereoscopic display device.

The memory interface 624 functions as the primary source and sink to modules in the Video FE 608 and the Video BE 610 that are requesting and/or transferring data to/from external memory 622. The memory interface 624 includes read and write buffers and arbitration logic.

The digital system 600 may be configured to operate as follows. Default shift values and directions for convergence of stereoscopic images are stored on the digital system 600. These default values are used until otherwise changed by a user via a touch on the stereoscopic touchscreen 620. The Video FE 608 receives stereoscopic image data for stereoscopic images from the stereoscopic imaging peripheral 628, applies enhancement techniques to the left and right images of the stereoscopic images, and stores the left and right images in external memory 622. Convergence adjustment software executing on the ICP 602 retrieves left and right images for each stereoscopic image from the external memory 622, shifts the left and right images according to the shift values and directions, and stores each resulting stereoscopic image in the external memory 622. Camera control software executing on the RISC processor 604 retrieves the resulting stereoscopic images from the external memory 622, and displays the stereoscopic images on the stereoscopic touchscreen 620.

Software executing on the RISC processor 604 receives a touchscreen event caused by user touching the stereoscopic touchscreen 620 while viewing the stereoscopic images to indicate a desired convergence point. This software indicates to convergence computation software executing on the ICP 602 that a touchscreen event has occurred and provides the coordinates of the touch point indicated in the touchscreen event.

The convergence computation software executing on the ICP 602 then applies the methods of FIG. 2 and FIG. 3 to determine shift values and directions that will converge a left image and a right image of a stereoscopic image to the user indicated convergence point. These shift values and directions will replace the shift values and directions currently being used by the convergence adjustment software.

The descriptions of illustrative embodiments and examples herein assume that that the search for a best match is performed by holding a region in the left image fixed and comparing it against shift positions across a larger region in the right image. One of ordinary skill in the art, having benefit of this disclosure, will understand other embodiments in which a region in the right image is fixed and the comparisons are made across a larger region in the left image without need for additional explanation. The descriptions also assume that both the left image and the right image are shifted. One of ordinary skill in the art, having benefit of this disclosure, will understand other embodiments in which only the left image or the right image is shifted without need for additional explanation.

Embodiments of the methods described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

The steps in the flow diagram herein are described in a specific sequence merely for illustration. Alternative embodiments using a different sequence of steps may also be implemented without departing from the scope of the present disclosure, as will be apparent to one skilled in the relevant arts by reading the disclosure provided herein.

While the invention has been described with respect to a limited number of embodiments, those skilled in the art, having benefit of this disclosure, will appreciate that other embodiments can be devised which do not depart from the scope of the invention as disclosed herein.

What is claimed is:

1. A method for automatic convergence of stereoscopic images, the method comprising:
receiving coordinates of a touch point on a touchscreen, wherein the touch point indicates a user-selected convergence point; and
converging a first stereoscopic image at the user-selected convergence point based on the touch point coordinates.

2. The method of claim 1,wherein converging a first stereoscopic image further comprises:
determining a first shift amount and a first shift direction based on the touch point coordinates; and
shifting at least one of a first left image and a first right image in the first stereoscopic image horizontally in the first shift direction by the first shift amount.

3. The method of claim 2, wherein converging a first stereoscopic image further comprises:
determining a second shift amount and a second shift direction based on the touch point coordinates; and wherein
shifting at least one of a left image further comprises shifting the first left image horizontally in the first shift direction by the first shift amount and shifting the first right image horizontally in the second shift direction by the second shift amount.

4. The method of claim 2, wherein determining a first shift amount further comprises:
translating the coordinates of the touch point to coordinates of a corresponding pixel in a second left image and a second right image of a second stereoscopic image;
searching the second left image and the second right image horizontally around the corresponding pixel to identify a sequence of pixels in the second left image that best matches with a sequence of pixels in the second right image, wherein each sequence of pixels includes the corresponding pixel; and
setting the first shift amount and the first shift direction based on horizontal disparity between the sequence of pixels in the second left image and the sequence of pixels in the second right image.

5. The method of claim 4, wherein searching the second left image further comprises searching the second left image and the second right image horizontally based on a horizontal disparity limit that specifies how much an image can be shifted horizontally.

6. The method of claim 5, wherein searching the second left image further comprises:
identifying a first one dimensional (1D) region of pixels of length 2N+1 in one of the second left image and the second right image, wherein the first 1D region is centered on the corresponding pixel and N is the horizontal disparity limit;
identifying a second 1D region of pixels of length 4N+1 in the other of the second left image and the second right image, wherein the second 1D region is centered on the corresponding pixel; and
computing correlation coefficients for the first 1D region and each sequence of pixels of length 2N+1 in the second 1D region, and
wherein a sequence of pixels in the second 1D region that provides a maximum correlation coefficient is a best match with the first 1D region.

7. The method of claim 6, wherein computing correlation coefficients cᵢ comprising computing:
$${c}_{i} = \frac{{\sum }_{m ∈ M} ( {l}_{m} - \overline{l} ) ( {r}_{m , i} - {\overline{r}}_{i} )}{\sqrt{{\sum }_{m ∈ M} {( {l}_{m} - \overline{l} )}^{2}} \sqrt{{\sum }_{m ∈ M} {( {r}_{m , i} - {\overline{r}}_{i} )}^{2}}}$$
$$M = \{ - N , … , N \}$$
wherein i={−N, . . . , N}, l̅ denotes a mean of pixel values in the first 1D region, lₘ denotes a pixel in an mth location in the first 1D region, r̅ᵢ denotes a mean of pixel values of an ith sequence of 2N+1 pixels in the second 1D region, r_{m, i} denotes a pixel at the mth location in the ith sequence of 2N+1 pixels in the second 1D region.

8. The method of claim 4, wherein the first stereoscopic image and the second stereoscopic image are a same stereoscopic image.

9. The method of claim 1, further comprising:
displaying the first stereoscopic image on a stereoscopic display.

10. The method of claim 9, wherein the stereoscopic display is comprised in the touchscreen.

11. An apparatus comprising:
a touchscreen;
means for receiving coordinates of a touch point on the touchscreen, wherein the touch point indicates a user-selected convergence point; and
means for converging a first stereoscopic image at the user-selected convergence point based on the touch point coordinates.

12. The apparatus of claim 11, wherein the means for converging a first stereoscopic image further comprises:
means for determining a first shift amount, a first shift direction, a second shift amount, and a second shift direction based on the touch point coordinates; and
means for shifting a first left image horizontally in the first shift direction by the first shift amount and shifting a second right image horizontally in the second shift direction by the second shift amount, the first left image and the first right image comprised in the first stereoscopic image.

13. The apparatus of claim 12, wherein the means for determining a first shift amount further comprises:
means for translating the coordinates of the touch point to coordinates of a corresponding pixel in a second left image and a second right image of a second stereoscopic image;
means for searching the second left image and the second right image horizontally around the corresponding pixel to identify a sequence of pixels in the second left image that best matches with a sequence of pixels in the second right image, wherein each sequence of pixels includes the corresponding pixel; and
means for setting the first and second shift amounts and the first and second shift directions based on horizontal disparity between the sequence of pixels in the second left image and the sequence of pixels in the second right image.

14. The apparatus of claim 13, wherein the means for searching the second left image further comprises:
identifying a first one dimensional (1D) region of pixels of length 2N+1 in one of the second left image and the second right image, wherein the first 1D region is centered on the corresponding pixel and N is a horizontal disparity limit that specifies how much an image can be shifted horizontally;
identifying a second 1D region of pixels of length 4N+1 in the other of the second left image and the second right image, wherein the second 1D region is centered on the corresponding pixel; and
computing correlation coefficients for the first 1D region and each sequence of pixels of length 2N+1 in the second 1D region, wherein a sequence of pixels in the second 1D region that provides a maximum correlation coefficient is a best match with the first 1D region.

15. The apparatus of claim 13, further comprising:
a stereo imaging component configured to capture the first stereoscopic image and the second stereographic image.

16. The apparatus of claim 13, wherein the first stereoscopic image and the second stereoscopic image are a same stereoscopic image.

17. The apparatus of claim 11, further comprising:
means for displaying the first stereoscopic image on a stereoscopic display.

18. The apparatus of claim 17, wherein the stereoscopic display is comprised in the touchscreen.

19. A computer readable medium storing software instructions that when executed in a digital system cause the digital system to perform a method comprising:
receiving coordinates of a touch point on a touchscreen, wherein the touch point indicates a user-selected convergence point; and
converging a first stereoscopic image at the user-selected convergence point based on the touch point coordinates.

20. The computer readable medium of claim 19, wherein converging a first stereoscopic image further comprises:
determining a first shift amount and a first shift direction based on the touch point coordinates; and
shifting at least one of a first left image and a first right image in the first stereoscopic image horizontally in the first shift direction by the first shift amount.
